(19) United States
(12) Patent Application Publication
(10) Pub. No.: US 2002/0089134 A1
(43) Pub. Date: Jul. 11, 2002

(54) Shopping bag cart

(76) Inventors: Marc Salzberger, Middle Village, NY (US); Robert Salzberger, Middle Village, NY (US)

Correspondence Address: Marc Salzberger, 84-42 Fleet Court #12A, Middle Village, NY, 11379, US

(21) Appl. No.: 09/757,858

(22) Filed: Jan. 10, 2001

(51) Int. Cl. B62B 1/00

(52) U.S. Cl. 280/47.24

(57) ABSTRACT

A one-time-use shopping cart for quick assembly by sales clerks when a customer is unable to hand carry a purchase. Designed for the carrying-slings of today's bags the cart suspends a loaded grocery bag spread eagle from extensions projecting out from the shoulders of the cart's cross arms. A bag can be slung from the front and the back of each cross arm. The larger types of plastic and paper bags with carrying handles in common use can also be accommodated.

### BACKGROUND

1. Field of Invention

This invention relates to shopping carts wherewith people wheel home their purchases.

2. Description of Prior Art

The prior art consists largely of three dimensional carts, often collapsible, into which shoppers place their acquisitions. Alternatively there are wheeled elongated frames onto which parcels are hooked.

Sharing some features of applicants' device are:

1. U.S. Pat. No. 5,678,842 to Hook, et. al. This collapsible cart with an elongated frame contains hooks from which parcels can be suspended. It resembles and operates somewhat like a golf or mail carrier's cart. Its purpose is to allow parcels to hang free, which “expands the cart's carrying capacity and avoids the need to stack a plurality of bags on top of one another.”

2. A similar idea is represented by U.S. Pat. No. 4,830,385 to Wallick, et al., which again offers hooks from which parcels are hung.

3. McArthur's free-standing, mobile storage rack is a stout cart on wheels designed for metal bins. It received U.S. Pat. No. 5,464,104.

The applicants' invention differs from all prior art in that:

It is specifically designed for today's plastic shopping bags.

It carries the bags in an unanticipated manner.

It is designed as a disposable, one-time-use item to be assembled and distributed by sales clerks to convenience customers with heavy purchases.

### OBJECTS AND ADVANTAGES

We are limited in our purchases not only by what we can afford and by what is available, but often also by what we are able to physically carry. The latter consideration is particularly constraining on the elderly.

If stores can be relied on to supply a disposable home shopping cart, a significant limitation on people's freedom to shop will be removed. It would profit merchants to convenience customers in this way.

### DRAWING FIGURES

FIG. 1 is a detailed front view of the cart. It shows two vertical tubes intersected by three shorter tubes whose extremities project slightly.

FIG. 2 renders a front and side perspective, with grocery bags suspended from the ventral and dorsal sides of the cart.

FIG. 3 shows a front and side view of the cart supporting a large department store type paper bag with handles.

FIG. 4 illustrates that the invention is reducible to three basic snap-on parts. It shows the vertical member, the crossbar and a wheel.

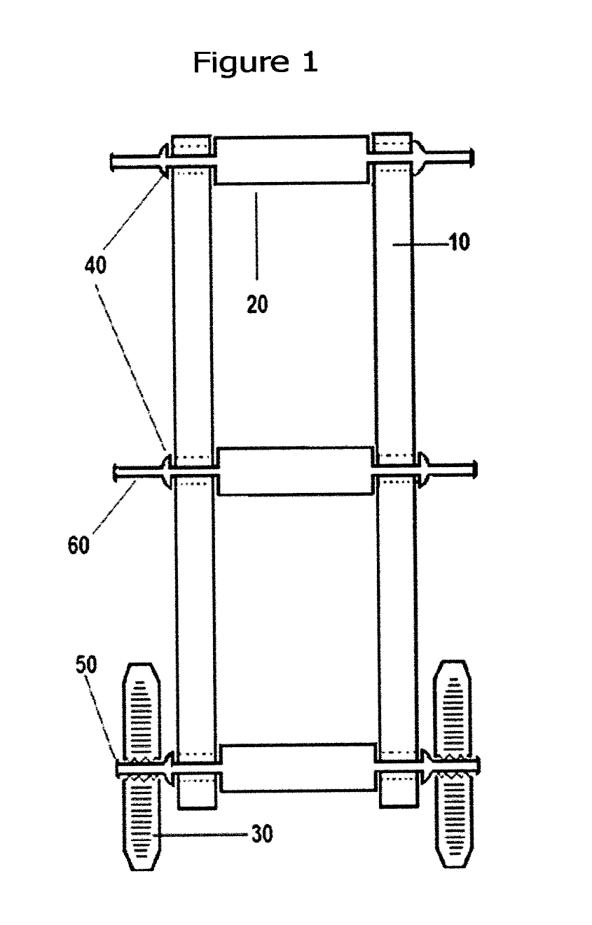

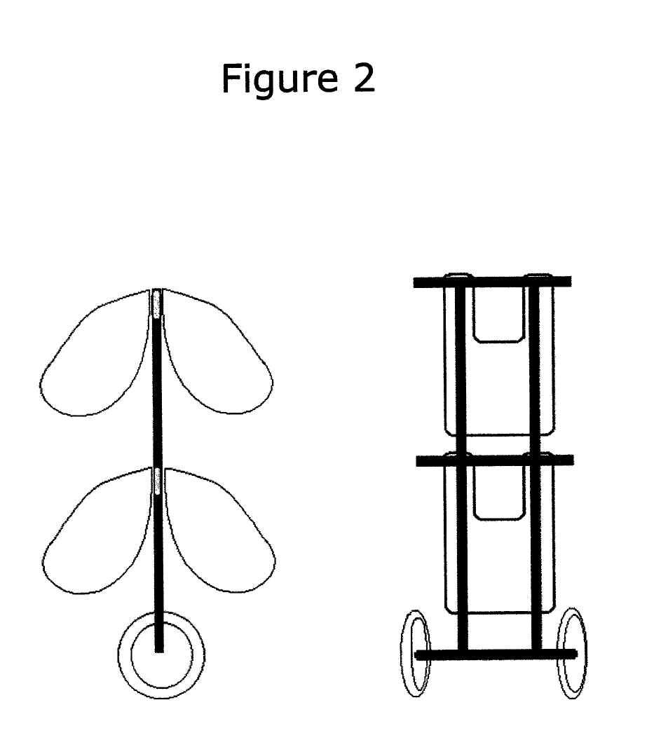

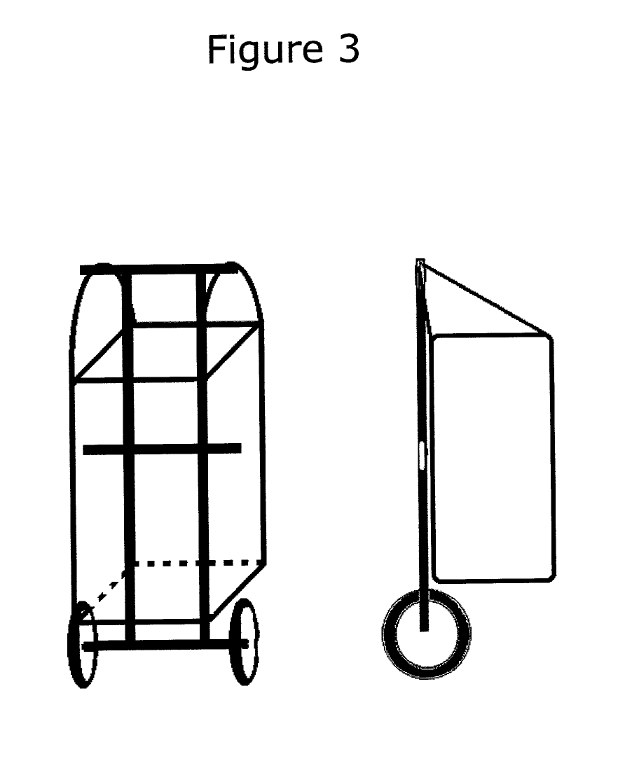

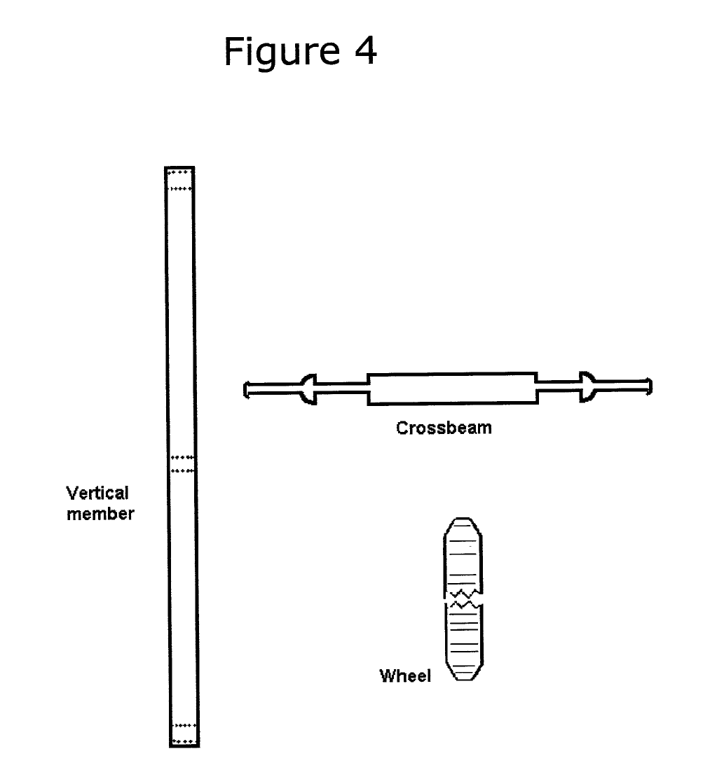

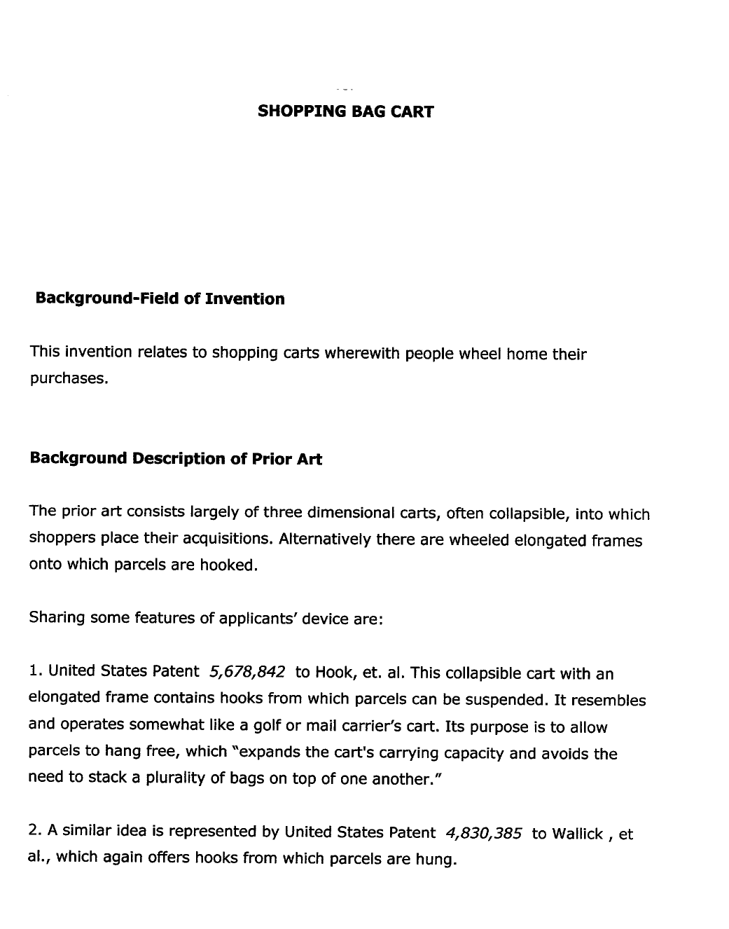

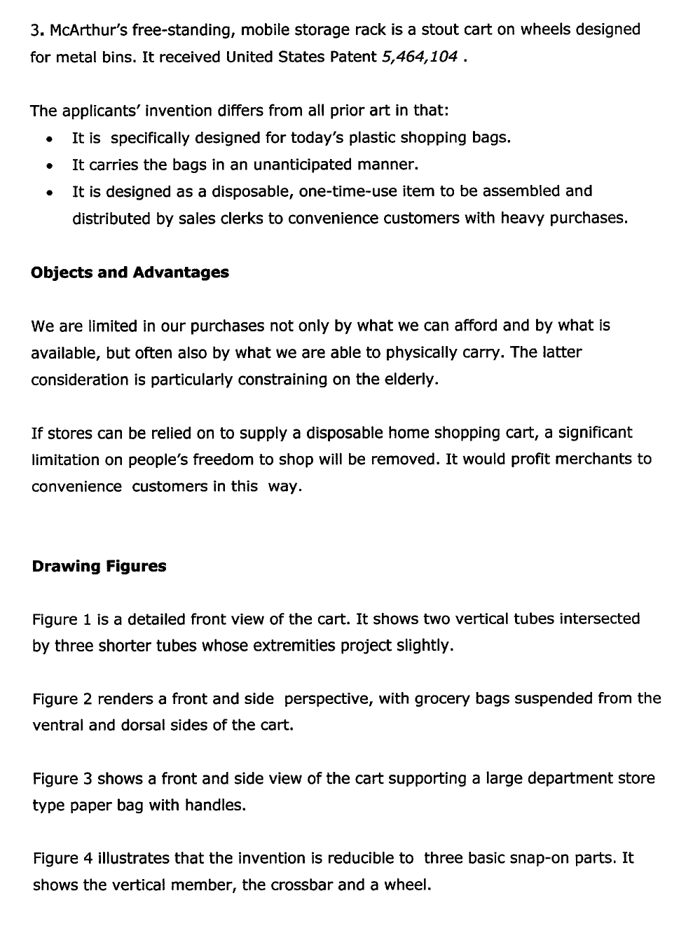

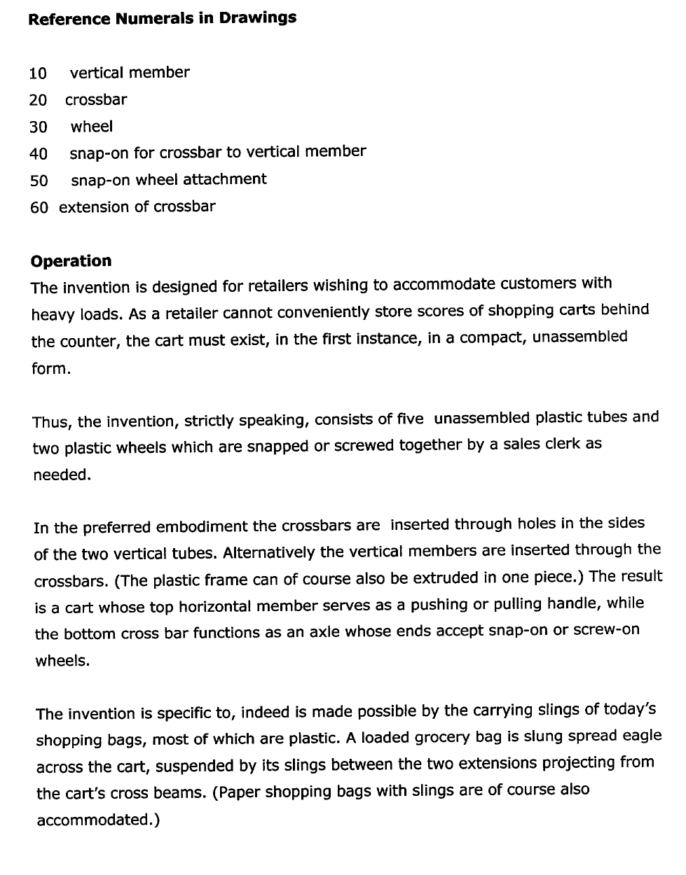

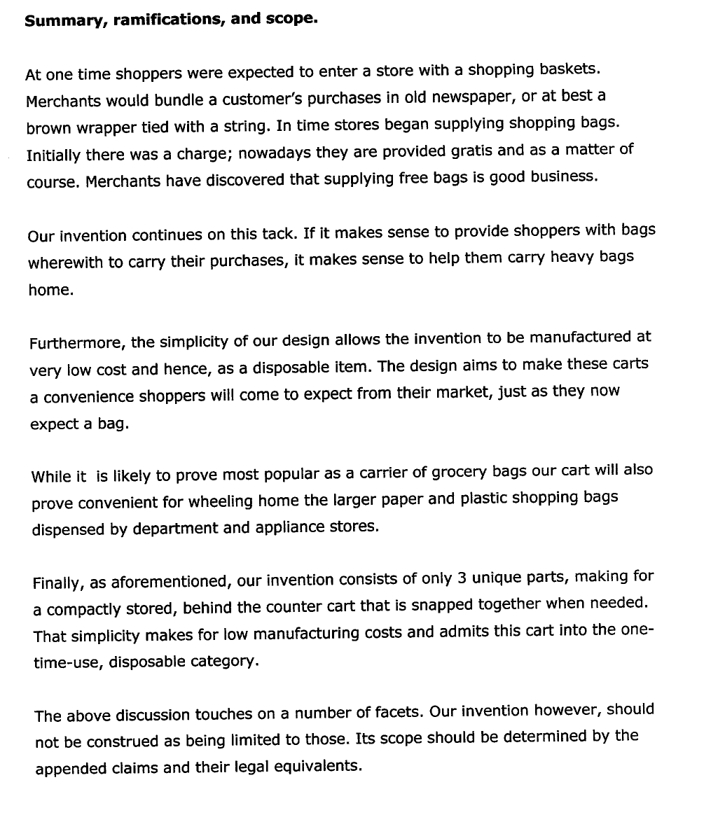

### REFERENCE NUMERALS IN DRAWINGS

10 vertical member

20 crossbar

30 wheel

40 snap-on for crossbar to vertical member

50 snap-on wheel attachment

60 extension of crossbar

### OPERATION

The invention is designed for retailers wishing to accommodate customers with heavy loads. As a retailer cannot conveniently store scores of shopping carts behind the counter, the cart must exist, in the first instance, in a compact, unassembled form.

Thus, the invention, strictly speaking, consists of five unassembled plastic tubes and two plastic wheels which are snapped or screwed together by a sales clerk as needed.

In the preferred embodiment the crossbars are inserted through holes in the sides of the two vertical tubes. Alternatively the vertical members are inserted through the crossbars. (The plastic frame can of course also be extruded in one piece.) The result is a cart whose top horizontal member serves as a pushing or pulling handle, while the bottom cross bar functions as an axle whose ends accept snap-on or screw-on wheels.

The invention is specific to, indeed is made possible by the carrying slings of today's shopping bags, most of which are plastic. A loaded grocery bag is slung spread eagle across the cart, suspended by its slings between the two extensions projecting from the cart's cross beams. (Paper shopping bags with slings are of course also accommodated.)

### SUMMARY, RAMIFICATIONS, AND SCOPE

At one time shoppers were expected to enter a store with a shopping baskets. Merchants would bundle a customer's purchases in old newspaper! or at best a brown wrapper tied with a string. In time stores began supplying shopping bags. Initially there was a charge; nowadays they are provided gratis and as a matter of course. Merchants have discovered that supplying free bags is good business.

Our invention continues on this tack. If it makes sense to provide shoppers with bags wherewith to carry their purchases, it makes sense to help them carry heavy bags home.

Furthermore, the simplicity of our design allows the invention to be manufactured at very low cost and hence, as a disposable item. The design aims to make these carts a convenience shoppers will come to expect from their market, just as they now expect a bag.

While it is likely to prove most popular as a carrier of grocery bags our cart will also prove convenient for wheeling home the larger paper and plastic shopping bags dispensed by department and appliance stores.

Finally, as aforementioned, our invention consists of only 3 unique parts, making for a compactly stored, behind the counter cart that is snapped together when needed. That simplicity makes for low manufacturing costs and admits this cart into the onetime-use, disposable category.

The above discussion touches on a number of facets. Our invention however, should not be construed as being limited to those. Its scope should be determined by the appended claims and their legal equivalents.

What is claimed is:

1. A cart for transporting one or more shopping or grocery bags having carrying slings, comprising:
a) a vertical frame made of rigid material and containing a vertical member and a crossbar, said crossbar projecting sufficiently beyond either side of said vertical member to constitute a wing for supporting said carrying slings of said shopping or grocery bags;
b) at least one wheel rotatably coupled to said vertical frame.

2. The cart of claim 1 wherein said vertical member and said crossbar are made of plastic.

3. The cart of claim 1 wherein said vertical member and said crossbar are manufactured as separate units and contain engagement means for snap-on attachment.

4. The cart of claim 1 wherein said vertical member and said crossbar are manufactured separately and contain threaded means for screwed on attachment.

5. A mobile rack for transporting plastic grocery or shopping bags having carrying slings, comprising:
a) a frame having two vertical members of equal length with a cross member connecting the upper ends of the vertical members and forming a handle;
b) an axle extending between the lower ends of said vertical members, said axle extending beyond each said vertical member a distance sufficient to mount a wheel on the ends of said axle;
c) a cross member connecting the ends of said vertical members at a predetermined distance between said axle and said handle and projecting on either side of said two vertical members a distance sufficient to constitute a surface area for said plastic shopping or grocery bags' carrying slings.

6. A disposable shopping cart for bags with carrying slings, made of separate pieces of plastic for out-of-factory assembly, and comprising:
a) two vertical members of equal size,
b) two shorter cross members of equal size,
c) two wheels,
d) and one of said cross members joining the upper ends of said vertical members by attachment means, and one the lower ends of said vertical members by attachment means, so as to form a rectangular frame whose upper segment extends a sufficient distance beyond either side of said vertical members, providing a surface area where from are suspended said carrying slings of said bags, while said lower cross member constitutes an axle and projects a sufficient distance on either side of said vertical members to provide attachment points for rotatably coupling said wheels.
